(19) United States
(12) Patent Application Publication
(10) Pub. No.: US 2010/0290218 A1
(43) Pub. Date: Nov. 18, 2010

(54) LED LAMP TUBE

(76) Inventors: MEI-LING YANG, Chunghe City (TW); Cheng-Hsun Wu, Chunghe City (TW)

Correspondence Address: LEONG C. LEI, PMB # 1008, 1839 YGNACIO VALLEY ROAD, WALNUT CREEK, CA, 94598, US

(21) Appl. No.: 12/466,392

(22) Filed: May 15, 2009

(51) Int. Cl. F21S 4/00

(52) U.S. Cl. 362/223

(57) ABSTRACT

For installation in a fluorescent lamp holder, a LED lamp tube installable is disclosed to include a lamp tube having a LED module mounted therein ad mounting holes located on each of the two distal ends thereof, two end caps respectively capped on the two distal ends of the lamp tube, each end cap having mounting holes corresponding to the mounting holes of the lamp tube and two contact pins extended out of one side thereof and electrically connected with the LED module for connection to an external fluorescent lamp holder to obtain the necessary working voltage for the LED module, and screws or rivets fastened to the mounting holes of the lamp tube and the end caps to affix the end caps to the lamp tube.

### BACKGROUND OF THE INVENTION

(a) Technical Field of the Invention

The present invention relates to a LED lamps and more particularly to the assembly structure of a LED lamp tube.

(b) Description of the Prior Art

Before the invention of “power-saving lamps”, people usually use tungsten lamp bulbs or fluorescent lamp bulbs for illumination. Because tungsten lamp bulbs have the drawback of high waste heat and high energy consumption, fluorescent lamp bulbs are preferably selected for home use or for use in business places where a big amount of electric power is consumed. Following the trends in energy saving and environmental protection practices, power-saving lamps become more and more popularly accepted. Nowadays, LEDs (light emitting diodes) have been intensively used in our daily life for the advantages of small size and low power consumption. Following fast development in LED technology, LEDs have been intensively used in many different fields, including indoor lighting, outdoor lighting, traffic lighting and signaling, outdoor advertising, and etc.

Basically, a LED comprises an electroluminescent semiconductor material located on a rack with lead wires and packaged with epoxy resin. Many LED lamps are commercially available. These commercial LED lamps have different configurations. Some commercial LED lamps have the shape of a fluorescent lamp tube.

A known LED lamp tube comprises a light transmissive lamp tube, which may be molded from transparent plastics, a circuit board mounted in the light transmissive lamp tube and carrying a plurality of LEDs, and two end caps affixed to the two ends of the light transmissive lamp tube with an adhesive or by means of a hook joint. When electricity is connected to the LEDs at the circuit board through the terminals at the end caps, the LEDs are driven to emit light.

According to the aforesaid design, the end caps may be forced away from the light transmissive lamp tube by accident during transportation or installation of the LED lamp tube. If one end cap of a LED lamp tube is damaged, loosened or disconnected from the light transmissive lamp tube, the LED lamp tube becomes useless.

### SUMMARY OF THE INVENTION

The primary purpose of the present invention is to provide a LED lamp tube, which keeps the end caps firmly secured to the light transmissive lamp tube thereof, avoiding a disconnection accident during transportation or installation.

To achieve this and other objects of the present invention, a LED lamp tube comprises a lamp tube having a LED module mounted therein ad mounting holes located on each of the two distal ends thereof, two end caps respectively capped on the two distal ends of the lamp tube, each end cap having mounting holes corresponding to the mounting holes of the lamp tube and two contact pins extended out of one side thereof and electrically connected with the LED module for connection to an external fluorescent lamp holder to obtain the necessary working voltage for the LED module, and fastening members fastened to the mounting holes of the lamp tube and the end caps to affix the end caps to the lamp tube. The fastening members can be screws or rivets.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a part of a LED lamp tube in accordance with the present invention.

FIG. 2 corresponds to FIG. 1, showing the end cap affixed to the lamp tube.

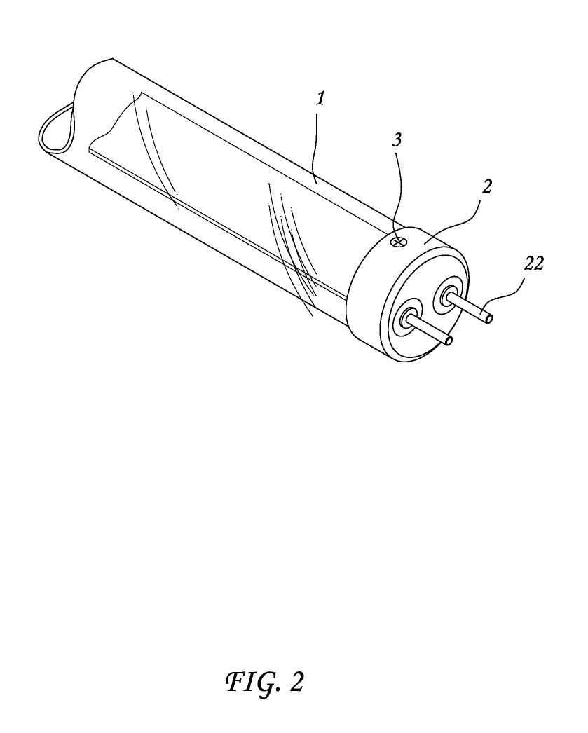

FIG. 3 is a side plain view of a part of the present invention, showing the relationship between the lamp tube and one end cap.

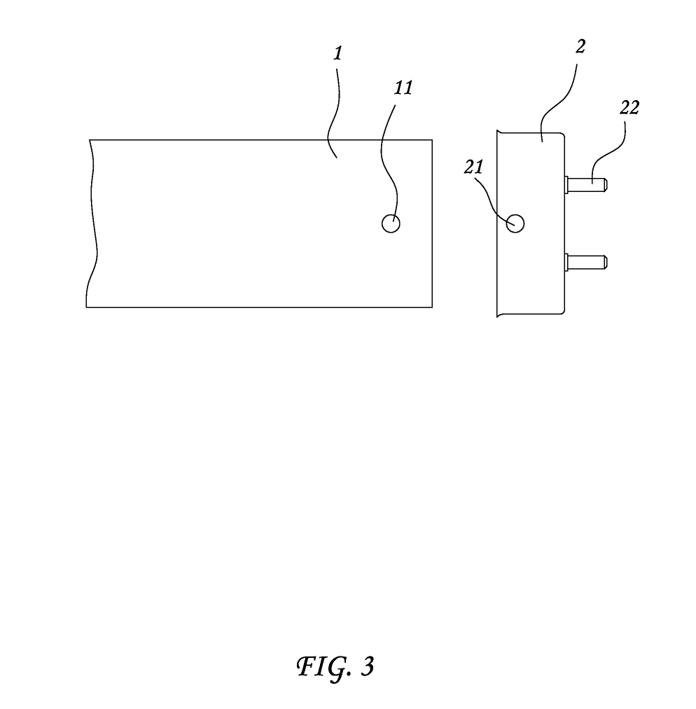

FIG. 4 corresponds to FIG. 3, showing the end cap affixed to the lamp tube.

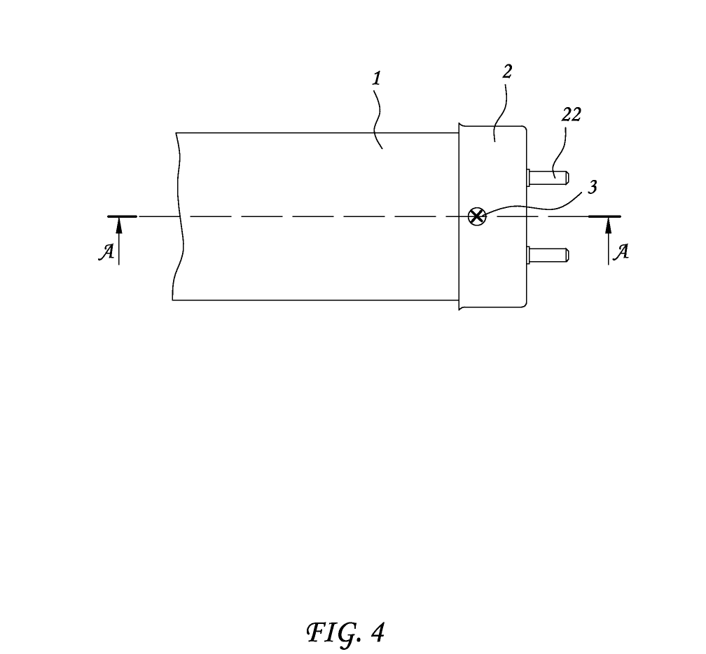

FIG. 5 is a sectional view taken along line A-A of FIG. 4.

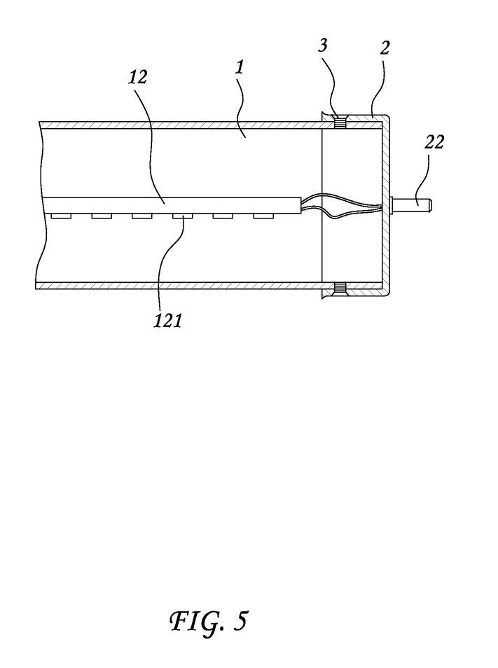

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

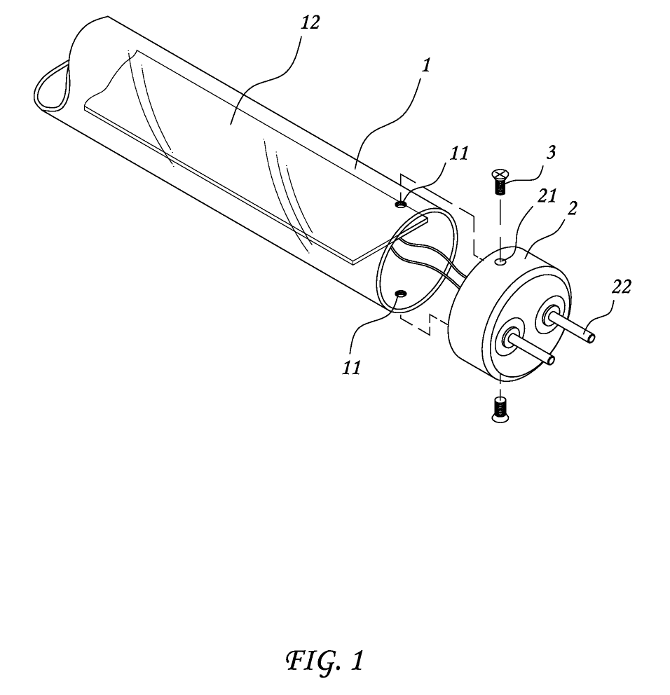

Referring to FIGS. 1˜5, a LED lamp tube in accordance with the present invention is shown comprising a lamp tube 1 and two end caps 2.

The lamp tube 1 is a light transmissive tube, having a LED module mounted therein. The LED module comprises a circuit board 12 and a plurality of LEDs (light emitting diodes) 121 installed in the circuit board 12. The lamp tube 1 has screw holes 11 equiangularly located on each of two distal ends thereof. The end caps 2 are respectively capped on the two distal ends of the lamp tube 1, each having two metal contact pins 22 perpendicularly extended out of one side thereof and a plurality of mounting through holes 21 located on the periphery corresponding to the screw holes 11 on each end of the lamp tube 1. The contact pins 22 of the end caps 2 are respectively electrically connected to the circuit board 12. During installation, the end caps 2 are respectively capped on the two distal ends of the lamp tube 1 to keep the mounting through holes 21 in alignment with the screw holes 11 respectively, and then screws 3 are respectively threaded into the respective screw holes 11 and the respective mounting through holes 21 to affix the end caps 2 to the lamp tube 1.

Further, rivets may be used instead of the screws 3 to affix the end caps 2 to the lamp tube 1.

Based on the aforesaid arrangement, the LED lamp tube can be installed in a conventional fluorescent lamp holder to substitute for a fluorescent lamp tube. After installation of the LED lamp tube in a conventional fluorescent lamp holder (not shown) and after the power switch at the fluorescent lamp holder is switched on, the LEDs 121 are turned on to emit light through the lamp tube 1.

A prototype of LED lamp tube has been constructed with the features of FIGS. 1˜5. The LED lamp tube functions smoothly to provide all of the features disclosed earlier.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A LED lamp tube installable in a fluorescent lamp holder, comprising:
a lamp tube holding a LED (light emitting diode) module therein, said lamp tube being light transmissive and having at least one mounting hole on each of two distal ends thereof;
two end caps respectively capped on the two distal ends of said lamp tube, each said end cap having at least one mounting hole corresponding to the at least one mounting hole on each of two distal ends of said lamp tube and two contact pins extended out of one side thereof and electrically connected with said LED module for connection to an external fluorescent lamp holder to obtain the necessary working voltage for said LED module; and
fastening members fastened to the at least one mounting hole on each of two distal ends of said lamp tube and the at least one mounting hole of each of said end caps to affix said end caps to said lamp tube.

2. The LED lamp tube as claimed in claim 1, wherein said fastening members are screws.

3. The LED lamp tube as claimed in claim 1, wherein said fastening members are rivets.
